(19) United States
(12) Patent Application Publication
(10) Pub. No.: US 2013/0159565 A1
(43) Pub. Date: Jun. 20, 2013

(54) METHOD AND APPARATUS FOR DATA TRANSFER OF TOUCH SCREEN EVENTS BETWEEN DEVICES

(71) Applicants: Olusanya T. Soyannwo, Palatine, IL (US); Steven W. Fischer, Lindenhurst, IL (US)

(72) Inventors: Olusanya T. Soyannwo, Palatine, IL (US); Steven W. Fischer, Lindenhurst, IL (US)

(73) Assignee: MOTOROLA MOBILITY, INC., Libertyville, IL (US)

(21) Appl. No.: 13/326,309

(22) Filed: Dec. 14, 2011

(51) Int. Cl. G06F 13/00

(52) U.S. Cl. 710/33

(57) ABSTRACT

Methods of processing touch screen events include generating a touch-enabled user interface (UI) with a source device that provides a source of content for being rendered on a separate rendering device having a touch-enabled display surface. Digital data is transferred from the source device to the rendering device via a communication link, such as a HDMI cable. The data transferred includes data providing the touch-enabled UI. Information is received by the source device via the communication link concerning touch screen events occurring on the touch-enabled UI rendered on the touch-enabled display surface of the rendering device. The touch screen events that are received from the rendering device are processed by the source device. Apparatus is also disclosed.

### BACKGROUND

Touch enabled surfaces, such as touch screens, are used in many electronic devices. Some examples include mobile devices such as smart phones, monitors of computers (lap-top, notebook, desk-top, tablet, etc.), televisions, remote controllers, media centers, printers, and screens in dashboards of vehicles and the like.

FIG. 1 is a diagram that depicts a typical model for touch screen event processing within an electronic device 10. The Touch Screen Driver 12 detects the “touch” occurrences on the touch screen 14 and creates an operating system (OS) specific “touch screen event” which is placed on the OS Event Stack 16. The OS 18 processes the event and typically passes the event to the active application 20 for more context specific processing. All of the above (i.e., detection and processing of touch events) is accomplished by the components of the single electronic device.

There are instances when the use of an application on one electronic device is desired to be extended to another device. In this case, the device providing the application is referred to as a “source” device and the device to which the application is extended is referred to as a “sink” device. As an example, electronics in the dashboard of a vehicle may be used to make a hands-free call from a separate mobile phone within the vehicle. Here, the mobile phone functions as the “source” device and the dashboard electronics function as the “sink” device. Likewise, the playing of video from a video playback device, such as a DVD player, on a television monitor uses the video playback device as a “source” device and the television monitor as the “sink” device. Of course, these represent just a few examples of possible source-sink combinations.

In some instances, it may be desirable or more convenient for a user to interface the sink device when controlling the functions of the source device. For example, see the hands-free calling example described above. However, when the source and sink devices are touch-enabled devices with touch-enabled display screen user interfaces, control via touch-screens incurs complications (i.e., control via touch and release, multi-touch, move or swiping events). Thus, a method and arrangement for transferring touch screen events between separate electronic devices, such as from a sink device to a source device, is desired.

### SUMMARY

This disclosure describes a method of processing touch screen events from the perspective of the source device. A touch-enabled user interface (UI) is generated by a first electronic device (i.e. source device) that provides a source of content for being rendered on a separate second electronic device (i.e. sink device) having a touch-enabled display surface. Digital data is transferred from the first electronic device to the second electronic device via a communication link, and the digital data includes data providing the touch-enabled UI. Information is received with the first electronic device via the communication link concerning touch screen events occurring on the touch-enabled UI rendered on the touch-enabled display surface of the second electronic device. The touch screen events that are received from the second electronic device are processed by the first electronic device.

This disclosure also describes a method of processing touch screen events from the perspective of the sink device. Digital data is received by a rendering device (i.e., sink device) having a touch-enabled display surface. This data is received from a separate source device via a communication link and includes a touch-enabled user interface generated by the source device. The touch-enabled UI is rendered on the touch-enabled display surface of the rendering device, and the rendering device detects occurrences of touch events of its touch-enabled display surface. The rendering device transfers information of the touch events via the communication link to the source device for processing by the source device.

This disclosure further describes apparatus for processing touch screen events. The apparatus includes a source electronic device having an operating system for processing touch screen events and a touch screen driver for receiving touch screen events from a separate rendering device. The touch screen driver has a High-Definition Multimedia Interface (HDMI) port for connection to a HDMI cable and is configured to transfer digital data, including data providing a touch-enabled user interface (UI), from the HDMI port to the rendering device. The touch screen driver is also configured to receive information via the HDMI port concerning touch screen events occurring on the touch-enabled UI as rendered on a touch-enabled display surface of the rendering device to enable the touch screen events to be processed by the source electronic device.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 is a schematic diagram of exemplary system architecture for providing touch screen event processing in an electronic device in accordance with an embodiment.

FIG. 2 is a schematic diagram of source and sink devices interconnected with a single HDMI cable according to an embodiment.

FIG. 3 is a schematic diagram of exemplary system architecture for data transfer of touch screen events from a sink device to a source device in accordance with an embodiment.

FIG. 4 is a sequence diagram of data transfer of a touch screen event from a sink device to a source device in accordance with an embodiment.

FIG. 5 is a view of a touch bounding box highlighted on a touch-enabled display surface in accordance with an embodiment.

FIG. 6 is a diagram of exemplary data blocks generated and transferred when identifying a touch screen event in accordance with an embodiment.

FIG. 7 is a flowchart of a method of processing touch screen events from the perspective of a source device in accordance with an embodiment.

FIG. 8 is a flowchart of a method of processing touch screen events from the perspective of a sink device in accordance with an embodiment.

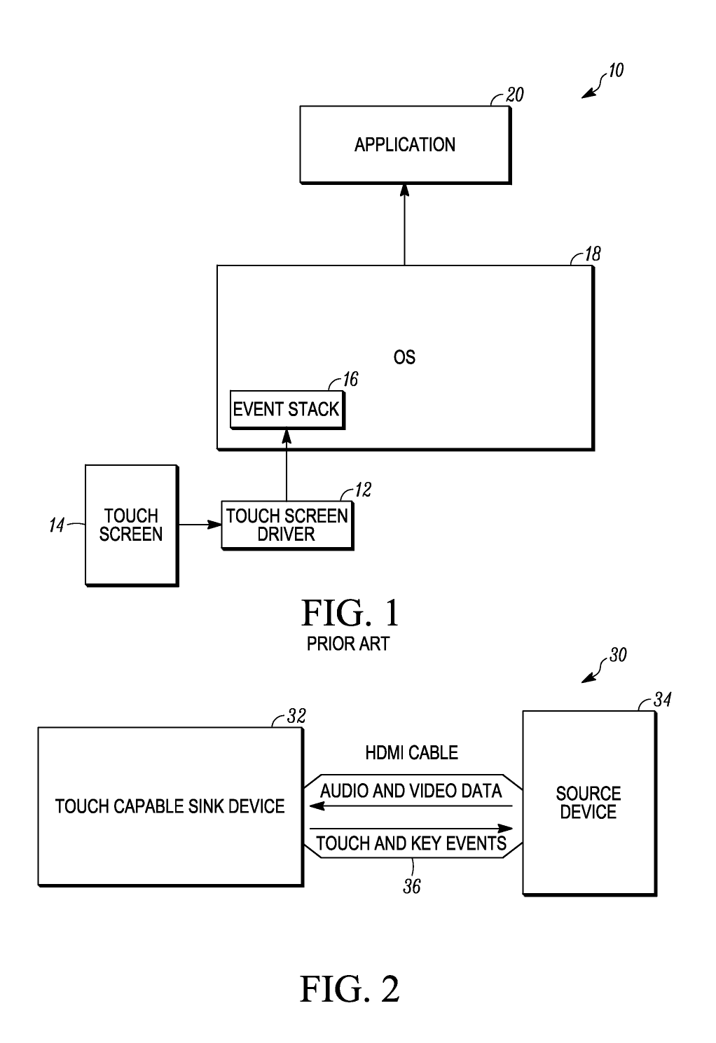

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

An assembly 30 in FIG. 2 includes a sink device or rendering device 32 connected to a source device 34 via a single High-Definition Multimedia Interface (HDMI) cable 36. At least the sink or rendering device 32 includes a touch screen. The source device 34 may or may not have a touch screen. As shown in FIG. 2, audio, video or other data is transferred from the source device 34 to the sink device 32 via HDMI cable 36 and touch screen events are transferred from the sink device 32 to the source device 34 via the HDMI cable. With this setup, the touch-enabled user interface (UI) of the source device 34 can be rendered or displayed on the touch-enabled surface of the sink device 32 via the HDMI connection and any user touch-screen touches or hard key presses on the sink device 32 are transferred to the source device 34 via the HDMI connection. Accordingly, from the perspective of the user, the application on the source device 34 is essentially totally experienced and controlled via viewing and interfacing the sink device 32.

Solely for purposes of example, a touch-enabled display surface or screen provided in connection with the dashboard of a vehicle, for instance as part of navigation equipment provided with the vehicle, can be used as a sink or rendering device as described above. Here, the dashboard electronics of the vehicle can include a HDMI port in the same manner that audio input jacks or the like are provided. Thus, a smart phone, tablet computer, or other mobile device generating a touch-enabled user interface (UI) can be used as a source device and can be connected to the HDMI port with an HDMI cable so that the dashboard touch-enabled display screen can be used to render an application of the source device and control thereof can be accomplished solely via the touch-enabled UI displayed on the sink device. Thus, the navigation touch-enabled display screen may be used to make telephone calls via the source device, to display video and audio content provided via the source device, to browse the Internet and stream content via the source device, or to use any other application available on the source device with all control thereof being made via interface with the sink device.

Another example of a source-sink combination may be with respect to presentations provided on relatively large touch-enabled display screens. Here, a smaller source device, such as a tablet, laptop or notebook computer or a smart phone could be used as the source device providing video and audio content for presentation on the larger touch-enabled display screen functioning as the sink device. The user touches the larger touch-enabled display screen of the sink device to control the presentation as opposed to being required to interface the UI directly on the source device.

Yet another example of such a combination is the use of a touch-enabled television monitor as a sink device for transferring touch screen events to an active source device, such as a video playback device (which may be a source device without a touch screen). Thus, the touch-enabled user interface display generated by the source device is rendered on the sink device (television monitor) and control over the source device is provided by touching the television monitor (sink device). Here, the source device is connected to the television; however, from the user's perspective, only the television is used to render the content and control the actions thereof. As in the other examples, no interaction with the source device is required. Also, as stated above, this example provides a source device that may not itself have a touch-enabled display surface or screen yet it is able to process touch events transferred to it from external sink devices having touch-enabled display surfaces.

The above description provides examples of a few potential arrangements of source and sink devices. However, this is not deemed to be a compressive list of all possible arrangements and any combination of source and sink devices are possible where the source device is providing the application and content and generating the user interface and where the sink device is used to render the content and user interface and detect and transfer touch events to the source device for actual processing of the touch screen events by the source device.

As shown in FIG. 2, the communications link between the source and sink devices may be a cable and may be a HDMI cable. HDMI is an interface provided by a single cable which permits uncompressed digital data to be transmitted to connected devices. HDMI specification version 1.4 was released on May 28, 2009 with versions 1.4a and 1.4b being released on Mar. 4, 2010 and Oct. 11, 2011, respectively. Version 1.4 includes an HDMI Ethernet Channel (HEC) which provides a 100 Mbit/s Ethernet connection between two HDMI connected devices so that the devices can share an Internet connection.

Consumer Electronics Control (CEC) is a feature designed to allow a user to command and control two or more CEC-enabled devices that are connected through an HDMI cable by using only one of the remote controls of the devices. For example, CEC may permit a television, set-top-box, and DVD player to be controlled via use of a remote controller of the television. CEC also permits individual CEC-enabled devices to command and control each other without intervention. The CEC is typically provided as a one-wire bidirectional serial bus carried on a HDMI cable. Thus, HDMI-CEC is a protocol that provides high-level control functions between various audiovisual products. Features supported by HDMI-CEC include, for instance, one touch play, system standby, one touch record, timer programming, deck control, device menu control, remote control pass through, and system audio control.

According to an embodiment, an addition to the HDMI Specification can be made to add the ability for sink device touch screen events to be transferred to an active source device. According to embodiments described herein, this data transfer may be achieved by two different methods via use of a single HDMI connection. One method uses the CEC (Consumer Electronic Control) one-wire bidirectional serial bus, and a second method uses the HEAC (HDMI Ethernet and Audio Return Channel) of a single HDMI connection.

In both methods, the direction of touch screen support is from the sink device back to the source device. According to at least some contemplated embodiments, the touch screen UI of the source device is mirrored onto the sink device.

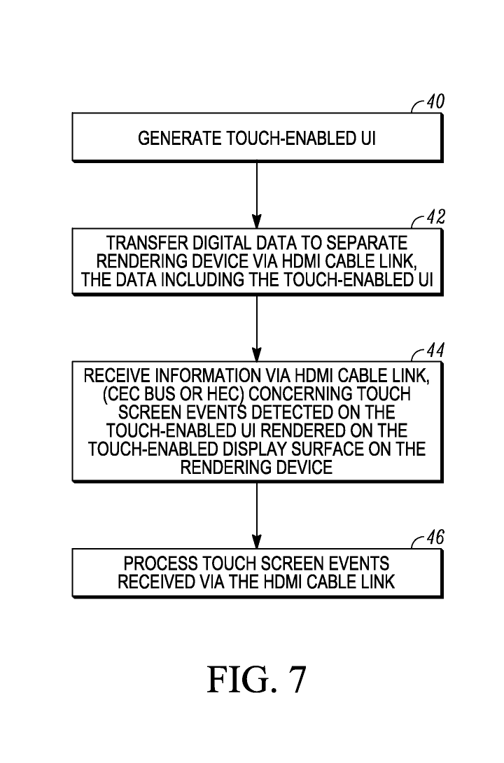

From the perspective of the source device (as shown in FIG. 7), the source device generates a touch enabled UI (see step 40) and transfers digital data to a separate sink or rendering device via a HDMI cable link. See step 42. This data transfer includes transfer of information needed to render the touch enabled UI generated in step 40. The source device receives information (see step 44) via the HDMI cable link via the CEC bus or HEC concerning touch screen events detected on a touch-enabled display surface of the rendering device. Thereafter, the source device processes the touch screen events and responds accordingly. See step 46.

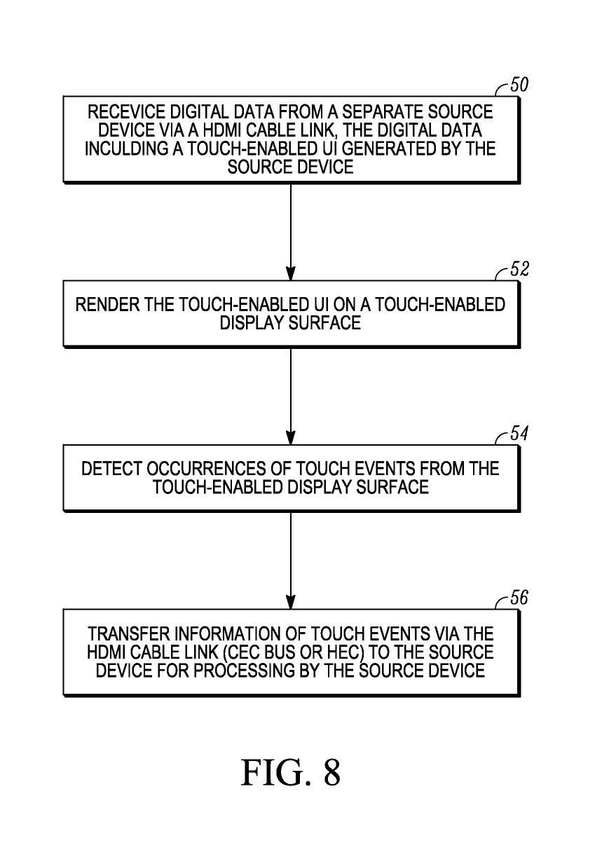

From the perspective of the sink or rendering device (as shown in FIG. 8), the sink device receives digital data from a separate source device via a HDMI cable link. See step 50. This data transfer includes transfer of information needed to render a touch enabled UI generated by the source device. The sink device renders or displays the touch-enable UI generated by the source device on the touch-enabled display surface of the sink device (see step 52) and detects occurrences of touch events from the touch-enabled display surface (see step 54). The sink device transfers information (see step 56) via the HDMI cable link via the CEC bus or HEC concerning touch screen events to the source device for subsequent processing by the source device.

With respect to the two methods noted above, the CEC based method is limited by data transfer rate over the CEC bus. Due to a relatively low data transfer rate, the CEC touch screen events will be limited in most instances to simple “press” and “release” type of events, with only limited ability to handle touch screen swiping or multi-touch events. As such, there may or may not be “move” events specified within the CEC method. Thus, this first method is particularly intended and useful for less complicated touch screen devices and use cases (i.e. simple touch and release uses).

The second method is HEAC-based or HEC (HDMI Ethernet Channel) based. In this method, the data rate of the HEC link is sufficiently fast (100 Mbits/s) to support touch screen “move” events. Thus, the second method is better for more complicated source devices enabling touch screen swiping and multi-touch events.

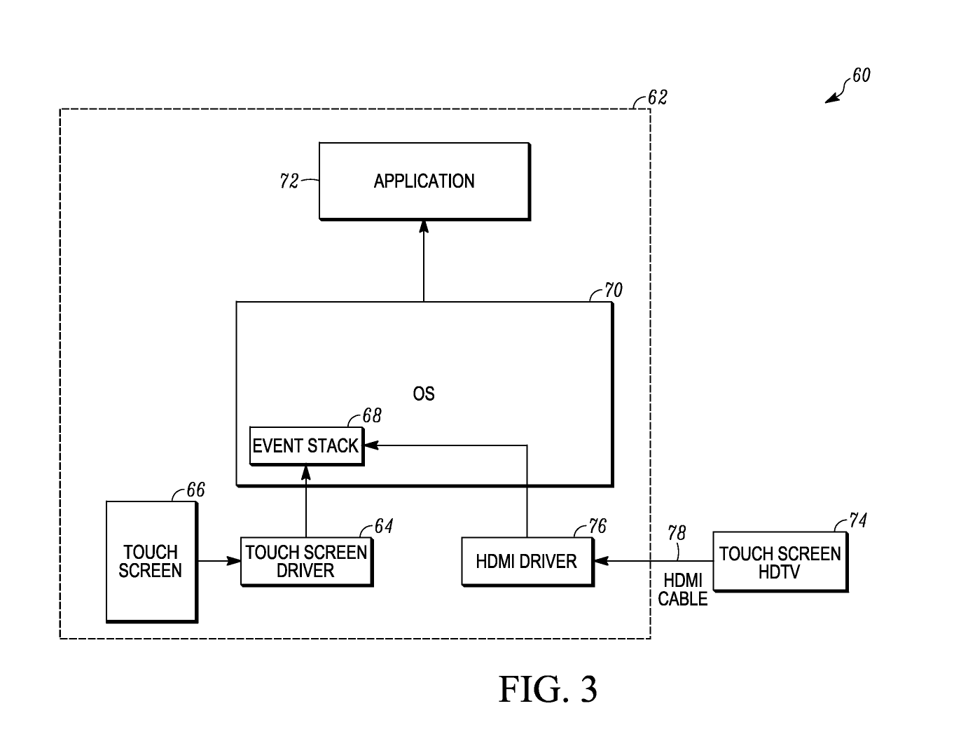

The diagram shown in FIG. 3 depicts an embodiment of a typical architectural model for touch screen event processing with respect to the CEC-based method and the HEC or HEAC based method. In the arrangement 60, a source device 62 includes a Touch Screen Driver 64 able to detect “touch” occurrences on touch-enabled display screen 66 of source device 62. The touch screen driver 64 creates an OS specific “touch screen event” which is placed on the OS Event Stack 68 within the source device 62. The OS 70 of the source device 62 processes the event and will typically pass the event to the active application 72 for more context specific processing by the source device 62. With respect to a touch screen event from a sink device 74 (such as an external HDTV having a touch-enabled display screen or surface), such an event can be received by a HDMI Driver 76 of the source device 62 from the sink device 74 via a single HDMI cable 78. The event is then packaged into an OS specific “touch screen event” similar to how the Touch Screen Driver 64 performs this function. After the OS specific “touch screen event” is created, it would be injected into the OS Event Stack 68 of the source device 62 for normal OS processing. As an alternative to the source device shown in FIG. 3, the source device may not possess a touch screen itself and may only be able to receive touch screen events from external sink devices having touch-enabled display surfaces. For instance, a DVD player used as a sink device may not itself have a touch screen and instead may rely on the touch-enabled display screen of an external sink device.

### CEC Method

The method for making use of the HDMI-CEC connection between the sink and source devices includes the allocation of a few additional touch-related operating codes (opcodes) for providing a Touch Control feature. These opcodes may include: <Touch Status>, <Touch Control Pressed>, <Touch Control Released>, and <Active Source>.

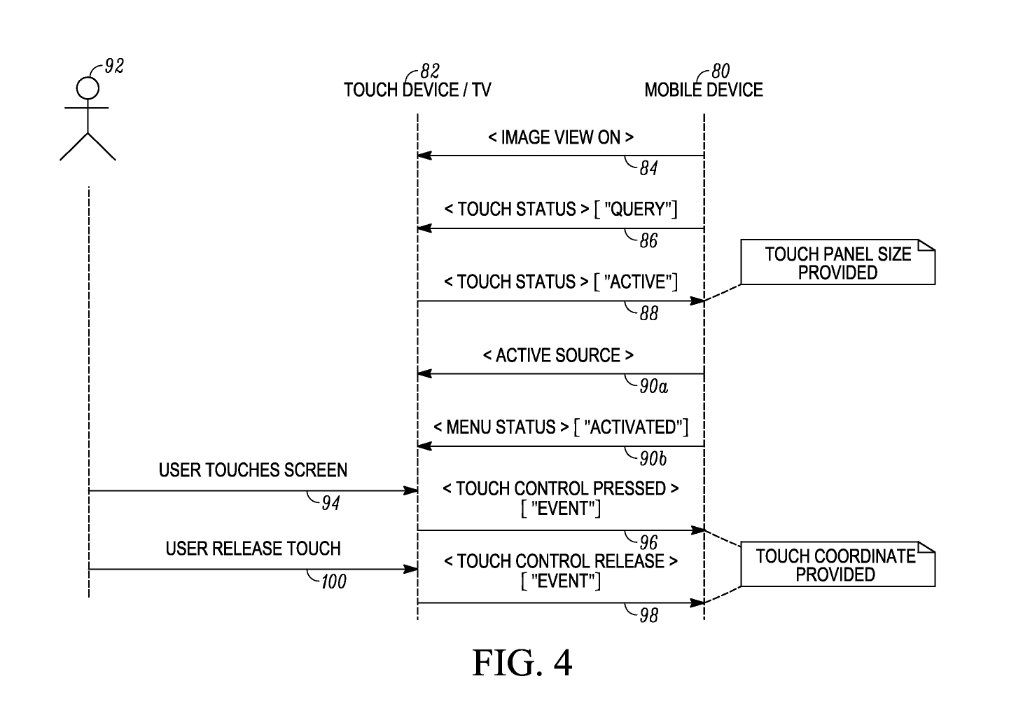

The Touch Control feature allows touch events to be sent via the HDMI-CEC protocol. A typical touch control sequence is shown in FIG. 4 between a source device, such as mobile device 80, and a sink device, such as a television 82 having a touch-enabled display screen. The source device 80 sends an <Image View On> operating code message 84 to the sink device 82 via a HDMI cable connection. This provides a command to the sink device 82 that the output of the source device 80 should be displayed on the display screen of the sink device 82. If the sink device 82 is in a Text Display state (e.g. Teletext), it switches to an Image Display state.

The source device 80 also sends a <Touch Status>[Query] message 86 to the sink device 82 to query for touch support. The sink device 82 responds with a <Touch Status>[Active] message 88 if touch is supported. Otherwise, the sink device 82 sends a <Touch Status>[Inactive] message. The <Touch Status>[Active] message 88 also contain the dimensions of the touch-enabled display screen panel of the sink device 82. This information is required by the source device 80 for touch event interpolation.

An <Active Source> message 90a and a <Menu Status>[Activated] message 90b are sent from the source device 80 to the sink device 82 when the source device 80 has stable video to display to the user via the touch-enabled display screen on the sink device 82. Thereafter, when a user 92 touches the touch-enabled display screen of the sink device 82 (see step 94), <Touch Control Pressed> messages 96 will be generated and sent to the source device 80. Coordinates of the touch location are appended to the messages 96. These messages may be sent repeatedly while the user engages (i.e., “touches”) the touch screen of the sink device 82. A <Touch Control Released> message 98 is generated by the sink device 82 when the user disengages the touch-enabled display screen of the sink device 82 (see step 100). In the event that a <Touch Control Released> is not received within a predetermined amount of time, a timeout shall occur for this event.

Should the sink device not be capable of providing this feature, it will be set to respond with a <Feature Abort> to all messages sent by a source device for this touch control feature.

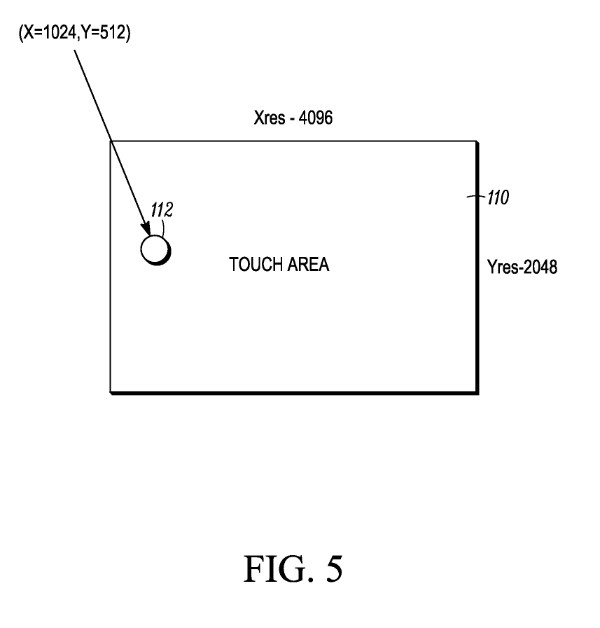

The coordinates of the touch location appended to the <Touch Control Pressed> messages 96 and the <Touch Control Release> messages 98 are transferred to the source device 80 in the form of Touch Control Pressed/Released Data Block Descriptors. For example, the touch screen 110 shown in FIG. 5 may have a panel resolution of 4096 (Xres)×2048 (Yres). An example of a “touch point” on the touch screen 110 is the “point” 112 highlighted in FIG. 5. The touch point 112 has coordinates X=1024 and Y=512 as shown in FIG. 5.

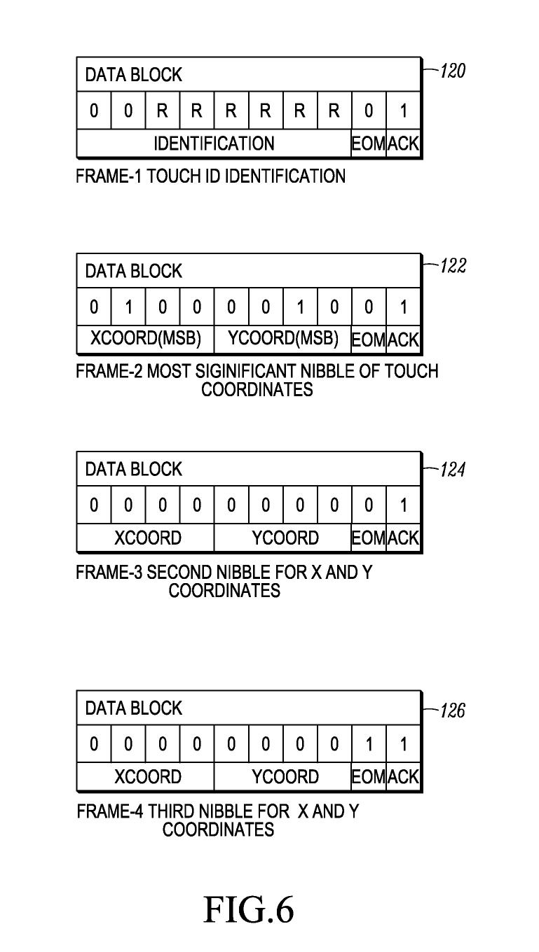

A touch point, such as touch point 112, may be written into a Data block as follows. The first data block 120, “Frame-1”, contains a Touch Identification. See FIG. 6. The Touch ID may be used to identify a unique event, for example, a multi-touch event. For a single touch event (represented by the data blocks in FIG. 6), the ID is zero (00), representing just one coordinate parameter. All other bits in the data block 120 providing frame-1 are marked “R” for “reserve” for future use. To represent the coordinates of a touch point, the frame-1 data block 120 will hold the Touch ID and the next frame (frame-2) data block 122 will hold the Most Significant four bits of the X-coordinate and Most Significant four bits of the Y-coordinate. As specified by the CEC block description, the EOM (end of message) and ACK (acknowledgment) will follow, indicating that additional data blocks are to follow. For example, the additional data blocks may be data blocks 124 and 126 with respect to “Second Nibble for X & Y Coordinates” and “Third Nibble for X & Y Coordinates”.

The Identification frame (i.e., frame-1 data block 120) described above may be used for <Touch Status>, <Touch Control Pressed> and <Touch Control Released> opcodes, according to Table 1 provided as follows.

TABLE 1

| Name | Value | | Description |
|---|---|---|---|
| <Touch Status> | “Query” | 0 | 2 bits of Identification |
| | “Active” | 1 | frame. Indicating touch |
| | “Inactive” | 2 | support. “Active” shall be |
| | | | followed by 3-bytes |
| | | | indicating display |
| | | | resolution. |
| <Touch Control Pressed> | “Single | 0 | 2 bits of Identification |
| | touch” | | frame. Indicating format of |
| | “Multi | 1 | parameter frames to follow. |
| | touch” | | |
| <Touch Control Released> | “Single | 0 | 2 bits of Identification |
| | touch” | | frame. Indicating format of |
| | “Multi | 1 | parameter frames to follow. |
| | touch” | | |

### HEAC (or HEC) Method

The method for making use of the HEC data connection between sink and source devices utilizes messaging across a UDP/IP stack built on top of the HEC data connection. UDP (User Datagram Protocol) is a transport layer protocol, and IP (Internet Protocol) is a network layer protocol. Both the sink and source devices are required to implement a UDP/IP stack in order for UDP messages to be sent and received.

If the sink and source devices have properly initialized UDP/IP stacks and the sink device has properly activated the HEC channel with the source device, bi-directional transfer of UDP messaging is possible between the devices. Both the sink and source devices communicate via the same pre-defined port number, for example, the port number 4364 (“HDMI” on a phone number pad) may be used.

The UDP payload contains the details of the message passed between the sink and source devices. Each message consists of a series of (8 bit) bytes representing the different fields of the message. Fields that are more than one byte in length are packed in network (big endian) order. The basic format for such a message is as shown in Table 2 provided below.

TABLE 2

| Byte | Field |
|---|---|
| 0 | <Feature ID> |
| 1 | <Version> |
| 2 | <Message ID> |
| 3+ | <Message Data> |

The <Feature ID> field permits multiple features to be built on top of this same protocol. For instance, CEC messaging in general could be specified to be carried over this protocol with very little if any change in the CEC message themselves. For this proposal, the only <Feature ID> value specified is for touch screen events. The <Version> field allows for further protocol updates per feature. The remaining fields are defined per feature. See below for the touch screen events messaging.

Due to the fact that UDP is a connectionless protocol and the fact that the loss of some messages in this protocol may result in a breakdown of this feature, a simple means of repeating messages is used to make the features more robust. In the message details for each feature, certain messages will be denoted as requiring repeated sending until an acknowledgement message is received. For these messages, the sending device may be set to transmit the message every 10 ms until the acknowledgement is received or 10 transmissions occur. After the 10^{th} message transmission, the sending device may be set to wait an additional 50 ms for the acknowledgement message, after which the transmission will assume to have failed. The description of each message that uses this behavior will detail what should happen if a transmission failure should occur.

In an example discussed below, the touch screen event <Feature ID> is 0x54 and the <Version> is 0x01. Table 3 denotes the possible messages related to the touch screen event feature.

TABLE 3

| Message | Value | Parameters | Description |
|---|---|---|---|
| GetCapabilities | 0x47 | None | Sent from the source to request |
| | | | touch screen event capabilities |
| Capabilities | 0x43 | [Max Touch | Sent from the sink in response |
| | | Points] | to a GetCapabilities message |
| | | [Width Pixel | |
| | | Range] | |
| | | [Height Pixel | |
| | | Range] | |
| Enable | 0x45 | None | Sent from the source to |
| | | | request touch screen events be |
| | | | enabled or from the sink in |
| | | | response to an Enable message |
| Disable | 0x44 | [Reason] | Sent from the sink or source |
| | | | to request touch screen events |
| | | | be disabled or in response to a |
| | | | sink Disable message |
| Press | 0x50 | [Touch ID] | Sent from the sink |
| | | [X Position] | denoting movement of a |
| | | [Y Position] | touch screen touch |
| Move | 0x4D | [Touch ID] | Sent from the sink denoting |
| | | [X Position] | a touch screen touch |
| | | [Y Position] | |
| Release | 0x52 | [Touch ID] | Sent from the sink denoting |
| | | [X Position] | the release of a touch |
| | | [Y Position] | screen touch |

The “GetCapabilities” message is sent by the source device to the sink device to determine if the sink device is capable of providing touch screen input, to determine what the sink touch screen area is in relation to the active HDMI pixel area, and to determine the multi-touch capabilities of the sink device. The “GetCapabilities” message is the first message sent by the source device to the sink device and must be sent after a HDMI video stream (source to sink) has been activated. Anytime the HDMI video stream resolution changes, the touch screen protocol must be “Disabled” explicitly by the source device and the initialization process, via “GetCapabilities”, must occur again.

The “GetCapabilities” message must be repeated, as described above with respect to message repetition requirement, until either a “Capabilities” message is received from the sink device or until a message transmission failure is determined. If a message transmission failure occurs, the source device is set to conclude that the sink device does not support this touch screen event protocol. After a first “Capabilities” message is received from the sink device, further “Capabilities” messages received are ignored. The “GetCapabilities” message does not include any additional fields.

The “Capabilities” message is sent by the sink device in response to a “GetCapabilities” message received from the source device. There are three possible responses to a “GetCapabilities” message received from a source device. These include: the message is ignored by the sink device causing the source device to eventually time out and assume the sink device is not capable of touch screen events; a “Capabilities” message can be returned by the sink device with a [Max Touch Points] field equal to zero (the remaining fields are sent as all zeros), which directly informs the source device that the sink device is not capable of touch screen events; and a “Capabilities” message can be returned by the sink device with a [Max Touch Points] field greater than zero (and the remaining fields are valid), which provides the required information to the source device about the touch screen capabilities of the sink device at the currently active video resolution. If repeated “GetCapabilities” messages are received by the sink device, the “Capabilities” message should be sent by the sink device in response to each.

The “Capabilities” message may include the following fields in the following order: [Max Touch Points], [Width Pixel Range], and [Height Pixel Range]. The [Max Touch Points] field will contain a number between 0 and 255 that denotes the maximum number of simultaneous touches that can be reported by the sink device. This value can be zero, which means that the sink device does not support the touch screen event feature. If the value is 1, the sink device only supports one touch event at a time. Values greater than 1 denote the sink touch screen supports multi-touch at the given number of simultaneous touches. The [Width Pixel Range] field contains the starting and ending pixel values of the touch area width, in relation to the HDMI resolution and how the image is being displayed on the sink device. The sink should take into account any manipulation of the HDMI frames that is occurring on the display side of the link (for instance stretching to fill the screen, etc.). The [Height Pixel Range] field contains the starting and ending pixel values of the touch area height in relation to the HDMI resolution and how the image is being displayed on the sink device. The sink device should take into account any manipulation of the HDMI frames that is occurring on the display side of the link (for instance stretching to fill the screen, etc.).

When the “Enable” message is sent from the source device to the sink device, it commands the sink device to begin reporting touch screen events. When the “Enable” message is sent from the sink device to the source device, it is in response to a sink device enable message and denotes that the sink device will begin sending touch screen events. Each time the sink device receives an “Enable” message from the source device it will respond with a return “Enable” message. The “Enable” message from the source device must be repeated, as described above with respect to message repetition, until either an “Enable” message is received from the sink device or a message transmission failure is determined. If a message transmission failure occurs, the source device may be set to wait at least 2 seconds and then try to re-establish communications with the sink device via the “GetCapabilities” message. After one “Enable” response is received from the sink device, further “Enable” messages received by the source device from the sink device are ignored. The “Enable” messages do not include any additional fields.

The “Disable” message may be sent from the sink or the source device. In general, the “Disable” message is sent to inform the other device that the reporting of sink touch screen events will be terminated. One of the included fields with a Disable message is the [Reason] field. This field may be one of two values, “Command” and “Response”. The “Command” value denotes a request to disable the reporting of touch screen events. The “Response” value denotes the message is in response to a “Disable/Command” received.

When a “Disable/Command” message is sent from the source device to the sink device, it commands the sink device to stop reporting touch screen events. When the “Disable/Command” message is sent from the sink device to the source device, it notifies the source device that something has changed related to the ability of the sink device to report touch screen events to the source device. For example, if the sink manipulation of the source HDMI video frames changes, the “Disable/Command” message implies that the previously understood touch screen pixel ranges (from the “Capabilities” message) are no longer valid.

In all cases, a “Disable/Command” message must be repeated, as described above with respect to message repetition, until either a “Disable/Response” message is received from the other device (sink or source) or a message transmission failure is determined. In all cases, a “Disable/Response” message will be sent by the device (sink or source) which receives a “Disable/Command” message. When a sink device receives a “Disable/Command” message, it will cease reporting touch screen events to the source, if it has not already stopped. When a source device receives a “Disable/Command”, it will assume the link is disabled, ignoring any future messages from the sink device until a “GetCapabilities” message is sent again to restart the protocol.

The “Press” message is sent from the sink device to the source device to denote the initial touch point of a touch event. The “Press” message includes a [Touch ID] field, an [X Position] field, and a [Y Position] field. The [Touch ID] field denotes the touch event number. The range of values is 0 to ([Max Touch Points]−1). This value is used to associate “Press”, “Move”, and “Release” events. The [X Position] field denotes the X coordinate of this initial touch point. This value is in reference to the HDMI video frame pixels. The [Y Position] field denotes the Y coordinate of this initial touch point. This value is in reference to the HDMI video frame pixels.

If a “Press” event occurs with a [Touch ID] that the source understands as still being pressed, then the source must assume a “Release” message was lost. In this case, the source should assume a “Release” occurred at the last known touch point of the previous touch event and begin another touch event starting with this new “Press” information. Events where the touch coordinates are outside the range defined by [Width Pixel Range] or [Height Pixel Range] are ignored.

The “Move” message is sent from the sink device to the source device to denote movement in a touch event touch point. The “Move” message includes a [Touch ID] field, an [X Position] field, and a [Y Position] field. The [Touch ID] field denotes the touch event number. The range of values is 0 to ([Max Touch Points]−1). This value is used to associate “Press”, “Move”, and “Release” events. The [X Position] field denotes the X coordinate where the touch point is moved. This value is in reference to the HDMI video frame pixels. The [Y Position] field denotes the Y coordinate where the touch point is moved. This value is in reference to the HDMI video frame pixels.

If a “Move” event occurs with a [Touch ID] that the source device understands as being released, then the source device must assume a “Press” message was lost. In this case, the source device uses the position information from this message as the initial touch point. Events where the touch coordinates are outside the range defined by [Width Pixel Range] or [Height Pixel Range] should be ignored.

The “Release” message is sent from the sink device to the source device to denote the end of a touch event and provide the final touch event touch point. The “Release” message includes a [Touch ID] field, an [X Position] field, and a [Y Position] field. The [Touch ID] field denotes the touch event number. The range of values is 0 to ([Max Touch Points]−1). This value is used to associate “Press”, “Move”, and “Release” events. The [X Position] field denotes the X coordinate of the final touch point. This value is in reference to the HDMI video frame pixels. The [Y Position] field denotes the Y coordinate of the final touch point. This value is in reference to the HDMI video frame pixels.

If a “Release” event occurs with a [Touch ID] that the source device understands as being released, then the source device must assume a “Press” message was lost. In this case, the source device uses the position information from this message as the initial and final touch point. Events where the touch coordinates are outside the range defined by [Width Pixel Range] or [Height Pixel Range] are ignored.

The details of each field in the above messages are defined in Table 4 provided below.

TABLE 4

| Field | Size (bytes) | Data (bytes array) |
|---|---|---|
| Height Pixel | 4 | [0] = starting height pixel (MSB) |
| Range | | [1] = starting height pixel (LSB) |
| | | [2] = ending height pixel (MSB) |
| | | [3] = ending height pixel (LSB) |
| Max Touch | 1 | [0] = max SINK simultaneous touch |
| Points | | points |
| Reason | 1 | [0] = 0x43 (Command) or 0x52 |
| | | (Response) |
| Touch ID | 1 | [0] = 0 to ([Max Touch Points]-1) |
| Width Pixel | 4 | [0] = starting width pixel (MSB) |
| Range | | [1] = starting width pixel (LSB) |
| | | [2] = ending width pixel (MSB) |
| | | [3] = ending width pixel (LSB) |
| X Position | 2 | [0] = X touch position (MSB) |
| | | [1] = X touch position (LSB) |
| Y Position | 2 | [0] = Y touch position (MSB) |
| | | [1] = Y touch position (LSB) |

Table 5 provides an example of a UDP payload for a touch screen press event.

TABLE 5

| Payload Byte | Field | Value |
|---|---|---|
| 0 | <Feature ID> | 0x54 |
| 1 | <Version> | 0x01 |
| 2 | <Message ID> = <Press> | 0x50 |
| 3 | [Touch ID] = ID 0 | 0x00 |
| 4 | [X Position] = 520 | 0x02 |
| 5 | | 0x08 |
| 6 | [Y Position] = 61 | 0x00 |
| 7 | | 0x3D |

The above referenced methods, including the CEC method and HEAC (or HEC) method, enable full control of the operation of a source device for user interaction with a touch screen UI device of the source device as rendered on the sink device. The HDMI connection ensures that high quality video and audio data is capable of being transferred only requiring a sole HDMI cable. Thus, the existence of the HDMI cable is leveraged via the CEC bus or HEC to provide full control of the source device without need to directly interface with the UI displayed on the source device. The touch events generated on the sink device are provided to the source device via the HDMI cable. The touch events occurring on the sink device are processed by the source device and the result is immediately visible on the display rendered on the sink device. Thus, the capabilities of a source device can be accessed and used solely via the interface of a touch enabled UI on the sink device.

The above referenced electronic devices for use as sink or source devices for carrying out the above methods can physically be provided on a circuit board or within another electronic device and can include various processors, microprocessors, controllers, chips, disk drives, and the like. It will be apparent to one of ordinary skill in the art that the modules, processors, controllers, units, and the like may be implemented as electronic components, software, hardware or a combination of hardware and software. The methods described above are not limited to electronic devices and combination of electronic devices disclosed above.

While the principles of the invention have been described above in connection with specific devices, apparatus, combinations, systems, and methods, it is to be clearly understood that this description is made only by way of example and not as limitation on the scope of the invention as defined in the appended claims.

We claim:

1. A method of processing touch screen events, comprising the steps of:
generating a touch-enabled user interface (UI) with a first electronic device that provides a source of content for being rendered on a separate second electronic device having a touch-enabled display surface;
transferring digital data from the first electronic device to the second electronic device via a communication link, the data including data providing the touch-enabled UI generated during said generating step;
receiving information with the first electronic device via the communication link concerning touch screen events occurring on the touch-enabled UI rendered on the touch-enabled display surface of the second electronic device; and
processing the touch screen events, received during said receiving step, with the first electronic device.

2. A method according to claim 1, wherein the communication link consists of a single High-Definition Multimedia Interface (HDMI) cable interconnecting the first electronic device to the second electronic device.

3. A method according to claim 1, wherein the touch screen events are received during said receiving step over a Consumer Electronic Controls (CEC) bidirectional serial bus of a HDMI cable which forms the communications link.

4. A method according to claim 1, wherein the touch screen events are received during said receiving step over a HDMI Ethernet Channel (HEC) of a HDMI cable which forms the communications link, and wherein the touch screen events are received during said receiving step as UDP (User datagram protocol) messages.

5. A method according to claim 1, wherein the touch screen events received during said receiving step include at least one of touch screen press and release events, touch screen multi-touch events, touch screen move events, and touch screen swiping events, and wherein the touch screen events include information of X and Y coordinates of the touch screen events occurring on the touch-enabled UI rendered on the touch-enabled display surface of the second electronic device.

6. A method according to claim 1, further comprising the step of controlling operation of the first electronic device solely via the touch screen events received during said receiving step.

7. A method according to claim 1, wherein the first electronic device includes a touch-enabled surface, and wherein the touch-enabled UI being transferred during said transferring step is a mirror image of a touch-enabled UI generated by the first electronic device for being rendered on the touch-enabled surface of the first electronic device.

8. A method according to claim 1, wherein the digital data transferred during said transferring step includes at least one of digital audio data and uncompressed digital video data.

9. A method according to claim 1, further comprising the step of receiving, with the first electronic device via the communication link, information of width and height pixel dimensions of the touch-enabled surface of the second electronic device.

10. A method according to claim 1, further comprising the step of receiving, with the first electronic device via the communication link, information concerning a maximum number of simultaneous touch events supported by the second electronic device.

11. A method of processing touch screen events, comprising the steps of:
receiving digital data with a rendering device having a touch-enabled display surface from a separate source device via a communication link, the digital data including a touch-enabled user interface generated by the source device;
rendering the touch-enabled UI on the touch-enabled display surface of the rendering device;
detecting occurrences of touches of the touch-enabled display surface of the rendering device; and
transferring information of the touches via the communication link from the rendering device to the source device for processing by the source device.

12. A method according to claim 11, wherein the communication link is provided by a High-Definition Multimedia Interface (HDMI) cable interconnecting the rendering device and the source device.

13. A method according to claim 12, wherein the information of the touches are transferred during said transferring step over at least one of a Consumer Electronic Controls (CEC) bidirectional serial bus of the HDMI cable and a HDMI Ethernet Channel (HEC) of the HDMI cable.

14. A method according to claim 13, wherein the information of the touches is transferred during said transferring step as UDP (User datagram protocol) messages.

15. A method according to claim 11, wherein the information of the touches transferred during said transferring step include at least one of X and Y coordinates of the touches, touch screen press and release events, touch screen multi-touch events, touch screen move events, and touch screen swiping events, and wherein the digital data received during said receiving step includes at least one of digital audio data and uncompressed digital video data.

16. A method according to claim 11, further comprising the step of transferring at least one of information of width and height pixel dimensions of the touch-enabled surface of the rendering device and information concerning a maximum number of simultaneous touch events supported by the rendering device to the source device via the communication link.

17. Apparatus for processing touch screen events, comprising:
a source electronic device having an operating system for processing touch screen events and a touch screen driver for receiving touch screen events from a separate rendering device, said touch screen driver having a High-Definition Multimedia Interface (HDMI) port for connection to a HDMI cable;
said touch screen driver being configured to transfer digital data from the HDMI port to the rendering device, the data including data providing a touch-enabled user interface (UI), and
said touch screen driver being configured to receive information via the HDMI port concerning touch screen events occurring on the touch-enabled UI as rendered on a touch-enabled display surface of the rendering device to enable the touch screen events to be processed by the source electronic device.

18. Apparatus according to claim 17, further comprising a rendering device and a HDMI cable interconnecting the rendering device with said HDMI port of said source electronic device, said rendering device having a touch-enabled display surface.

19. Apparatus according to claim 18, wherein said touch screen driver of said source electronic device is configured to receive information of touch screen events over a Consumer Electronic Controls (CEC) bidirectional serial bus of the HDMI cable.

20. Apparatus according to claim 18, wherein said touch screen driver of said source electronic device is configured to receive information of touch screen events over a HDMI Ethernet Channel (HEC) of the HDMI cable, and wherein the touch screen events are received by the touch screen driver as UDP (User datagram protocol) messages.
